(19) United States
(12) Patent Application Publication
(10) Pub. No.: US 2003/0010112 A1
(43) Pub. Date: Jan. 16, 2003

(54) Monitor and warning apparatus and methods

(76) Inventors: David Yekutiely, Ramat HaSharon (IL); Barak Yekutiely, Teaneck, NJ (US)

Correspondence Address: Dekel Patent Ltd., Apt. 4, 12 HaEgoz Street, Rehovot, IL

(21) Appl. No.: 09/901,902

(22) Filed: Jul. 11, 2001

(51) Int. Cl. G01F 23/00

(52) U.S. Cl. 73/290 R

(57) ABSTRACT

Apparatus including a mass suspended from a filament, and a sensor adapted to sense a change in a time derivative of a spatial position of the mass when the mass moves from a first material to a second material. The change in the time derivative may include acceleration, deceleration, jerk or impact of the mass, for example. The change in the time derivative may be due to the mass being removed from a liquid to a gas, lowered from a gas to a liquid or abutting against a solid surface, such as the bottom of a well, for example. The change in the time derivative of a spatial position of the mass may also be due to seismicity.

### FIELD OF THE INVENTION

The present invention relates generally to fluid level gauges or monitors, and particularly to apparatus and methods for sensing fluid levels and depths, and for early warning of earthquakes and seismicity.

### BACKGROUND OF THE INVENTION

In many localities, water is supplied to consumers by pumping the water from wells. Water wells can be quite deep, some reaching depths of over 500 meters. In states or countries that have low amounts of precipitation, well water is a precious commodity, and wells are intensively pumped to meet the consumer demand. In such cases, the level of the water in the well can reach low levels, and the pumped water can become mixed with sand or sea water. It is readily understood that such a situation is undesirable and intolerable. The sand that is pumped with the water can foul and damage irrigation pumps of agricultural consumers. The quality of water mixed with sea water is intolerable and dangerous for drinking purposes. It is thus imperative to monitor the water level in the well, in order to know when to stop pumping water from the well. Unfortunately, the prior art has no precise and robust solution for water management in wells, aquifers and the like.

### SUMMARY OF THE INVENTION

The present invention seeks to provide a novel apparatus and methods that can be used to monitor water level and depth in a well. Although the present invention is described herein for water wells, nevertheless the invention is applicable for any kind of fluid, such as oil. The present invention also seeks to provide a novel system for early warning of earthquakes, and the fluid level apparatus may be incorporated in the early warning system.

There is thus provided in accordance with a preferred embodiment of the present invention apparatus including a mass suspended from a filament, and a sensor adapted to sense a change in a time derivative of a spatial position of the mass when the mass moves from a first material to a second material. The change in the time derivative of a spatial position of the mass may include acceleration, deceleration, jerk or impact of the mass, for example. The change in the time derivative may be due to the mass being removed from a liquid to a gas, lowered from a gas to a liquid or abutting against a solid surface, such as the bottom of a well, for example. The change in the time derivative mass may also be due to seismicity.

In accordance with a preferred embodiment of the present invention the sensor includes an accelerometer or a load cell.

Further in accordance with a preferred embodiment of the present invention an impact enhancer is attached to the mass.

There is also provided in accordance with a preferred embodiment of the present invention apparatus including a mass suspended from a filament and disposed in a material, and a sensor adapted to sense a change in a time derivative of a spatial position of the mass due to relative movement between the mass and the material.

There is also provided in accordance with a preferred embodiment of the present invention a system including a detector adapted to provide a signal corresponding to an early warning of an earthquake, and a data processing unit adapted to receive the signal and send a message based upon the signal to a subscriber.

In accordance with a preferred embodiment of the present invention the data processing unit is in operative communication with a plurality of the detectors.

Further in accordance with a preferred embodiment of the present invention the data processing unit is operative to send the message via a telecommunications medium.

Still further in accordance with a preferred embodiment of the present invention the subscriber receives the message through a fee transaction.

Additionally in accordance with a preferred embodiment of the present invention the data processing unit is in interactive communication with the subscriber.

There is also provided in accordance with a preferred embodiment of the present invention a method including providing an early warning of an earthquake, and sending a message based upon the early warning to a subscriber. The signal may be received from an early warning earthquake detector or a network of early warning earthquake detectors.

### BRIEF DESCRIPTION OF THE DRAWINGS

The present invention will be understood and appreciated more fully from the following detailed description taken in conjunction with the appended drawings in which:

FIG. 1 is a simplified pictorial illustration of a apparatus for sensing fluid levels and depths, and for early warning detection of earthquakes and seismicity, constructed and operative in accordance with a preferred embodiment of the present invention;

FIGS. 2A and 2B are simplified pictorial illustrations of operation of the apparatus of FIG. 1, wherein FIG. 2A illustrates a mass suspended from a filament initially at an equilibrium position, and FIG. 2B illustrates the mass moved from the initial equilibrium position until impact with a surface;

FIG. 2C is a simplified pictorial illustration of the mass being lifted from a first material to a second material; and

FIG. 3 is a simplified illustration of a system for early warning of earthquakes or other seismicity, constructed and operative in accordance with a preferred embodiment of the present invention.

### DETAILED DESCRIPTION OF THE PRESENT INVENTION

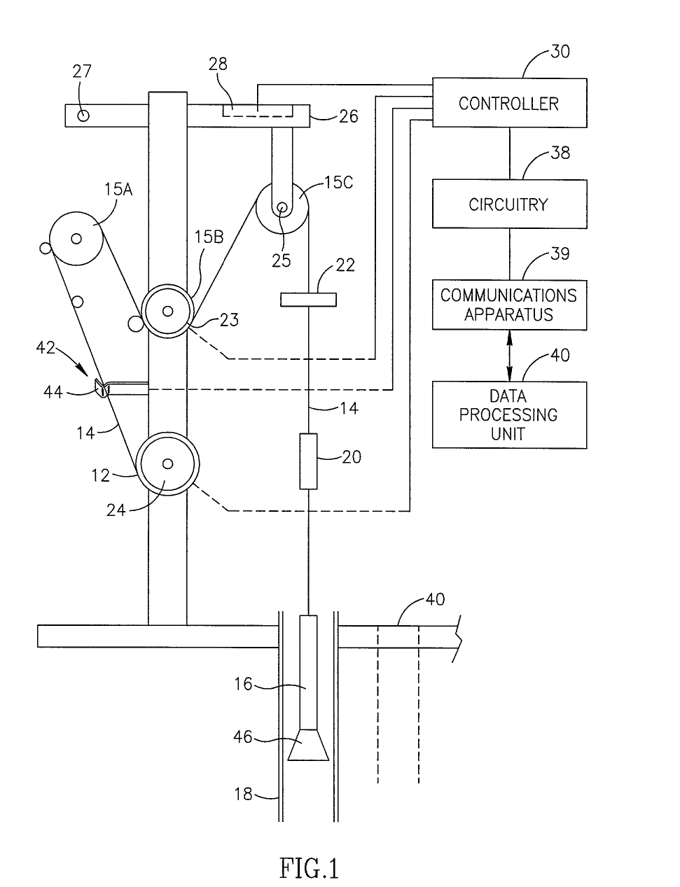

Reference is now made to FIG. 1, which illustrates apparatus 10 constructed and operative in accordance with a preferred embodiment of the present invention.

Apparatus 10 preferably includes a spool 12 of a filament 14. The term “filament” encompasses any string, wire, thread, fishing line, cord or rope and the like. Filament 14 may be wrapped one or more times around one or more bobbins, such as bobbins 15A, 15B and 15C, and be attached to a mass 16. In one embodiment of the invention, mass 16 may be lowerable into a generally vertical elongate tube 18. Such a tube is generally installed in most water wells for testing and sampling purposes, and runs virtually the entire depth of the well. Alternatively, mass 16 may be lowered into a hole 19 drilled into the ground, or any other kind of aperture or pipe.

Mass 16 may be fashioned generally in the form of a cylinder. It is appreciated, however, that the invention is not limited to such a cylindrical shape, and mass 16 may have any other suitable shape. In accordance with a preferred embodiment of the present invention, mass 16 is suspended at or near the distal end of filament 14 and an auxiliary mass 20 is attached to filament 14 proximal to mass 16. A stop 22 may be positioned distally relative to the bobbins (such as bobbin 15C) and proximal to auxiliary mass 20.

Spool 12 is preferably rotated by means of a filament mover, such as but not limited to, a motor 24 attached thereto. Motor 24 may be a compact servomotor, for example, mounted on a central shaft of spool 12. Rotation of spool 12 either raises or lowers mass 16. A filament-displacement sensor, such as but not limited to, a shaft encoder 23, may be mounted at bobbin 15B. Shaft encoder 23 senses the rotation of bobbin 15B, and thus the distance displaced or traveled by filament 14.

Bobbin 15C is preferably supported by bearings 25 mounted in a support member 26 that is attached to a sensor 28. Sensor 28 is adapted to sense a change in a time derivative of a spatial position of mass 16, as explained further in detail hereinbelow. Sensor 28 may be an accelerometer, load cell, strain or tension gauge, for example, which can sense upward or downward flexure or movement of support member 26 (and with it upward or downward movement of mass 16) about a pivot 27.

Suitable microswitches (not shown) may be provided to sense if mass 16 has risen to stop 22 and stop the rotation of motor 24. Additionally or alternatively, bobbin 15C may be provided with a clutch or ratchet mechanism (not shown), so that if mass 16 rises to stop 22, bobbin 15C does not over-rotate.

Sensor 28, motor 24 and shaft encoder 23 are preferably in communication with a controller 30, which comprises control circuitry 38. Circuitry 38 preferably includes any components typically used for operating the above-named parts, such as but not limited to, motor controls or solid state relays and the like, as is well known to the skilled artisan. Circuitry 38 may also include various environmental sensors, such as but not limited to, temperature sensors, humidity sensors, wind sensors and the like. Circuitry 38 may further comprise communications apparatus 39, such as but not limited to, a modem or transceiver, for transmitting and/or receiving data to/from a data processing unit 40.

There is preferably provided a device 42 that facilitates winding filament 14 on and from spool 12 without snagging, and which helps maintain filament 14 generally taut at all times. Device 42 may comprise a lever arm 44 through which filament 14 may be passed. Lever arm 44 may be in communication with controller 30, and is adapted to move back and forth (generally in the direction into and out of the sheet of the drawing). Lever arm 44 moves filament 14 back and forth as filament 14 is wound on or from spool 12, thereby preventing filament 14 form bunching up in one place on spool 12 and maintaining filament 14 generally taut at all times.

In accordance with a preferred embodiment of the present invention an impact enhancer 46 is attached to mass 16. Impact enhancer 46 may comprise a funnel or bell-shaped object (or other arbitrary shapes) with or without an open end. One purpose of impact enhancer 46 is to increase the impact of mass 16 when mass 16 impacts a surface, such as the ground, the bottom of a well or the top of water, for example.

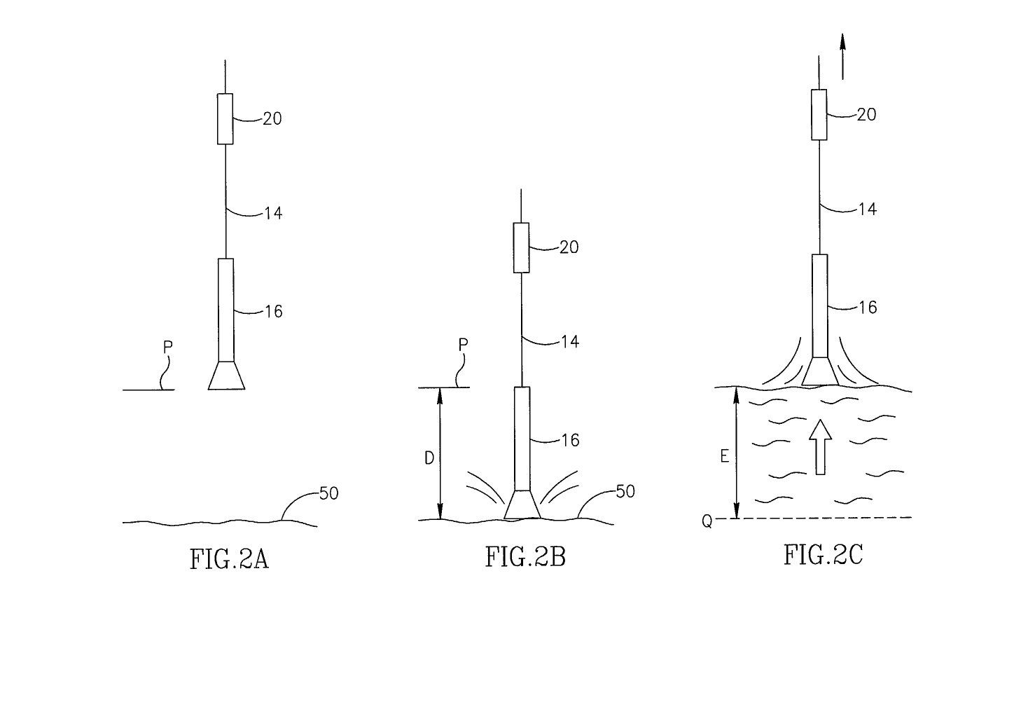

The operation of apparatus 10 is now described with further reference to FIGS. 2A and 2B. Mass 16 is initially at an equilibrium position P (FIG. 2A). At the equilibrium position P, mass 16 may be suspended in a material, e.g., air or volume of water, or partially suspended in a first material and partially submerged in a second material, e.g., partially suspended in air and partially submerged in a liquid such as water, or fully submerged in a material, or any other kind of equilibrium position. Mass 16 may then be moved, such as by the action of motor 24, so that mass 16 is lowered from the initial equilibrium position P, until mass 16 impacts a surface 50, such as the ground, the bottom of a well or the top of water, for example (FIG. 2B). Prior to impact with surface 50, mass 16 may move downwards at a generally constant velocity, which means that the acceleration/deceleration of mass 16 is generally zero. However, at impact the deceleration of mass 16 is some finite, measurable value, which may be sensed and measured by sensor 28. The distance D traveled by mass 16 from equilibrium position P to the point of impact with surface 50 may be sensed and measured by shaft encoder 23.

Thus, apparatus 10 is capable of sensing and measuring the change in a time derivative of a spatial position of mass 16 due to relative movement between mass 16 and a material (e.g., air or water). As is well known in mathematics and physics, the time derivative of a spatial position of mass 16 is the velocity (dz/dt) of mass 16. The change in the time derivative of a spatial position of mass 16 includes acceleration or deceleration (d²z/dt²) and jerk (d³z/dt³), for example. Apparatus 10 is capable of correlating the change in a time derivative of the spatial position of mass 16 with the distance traveled by mass 16 from the equilibrium position P, as described above.

Controller 30 may employ some predetermined minimum value of the change in a time derivative of a spatial position of mass 16, so as to ignore spurious or insignificant changes in the time derivative. Moreover, the impact with surface 50 may be enhanced by impact enhancer 46, so that the change in the time derivative is clear and easily recognizable. The distance D traveled by mass 16 may be measured, recorded and processed, such as by data processing unit 40. In such a manner, apparatus 10 may be used to monitor water level in a well, even deep wells.

The equilibrium position P may be self-calibrated with respect to some known calibration point, for example, the position of stop 22, the ground or the bottom of a well. Apparatus 10 may be self-calibrated by moving mass 16 from any point back to the initial location (i.e., the known calibration point) and checking if the position is measured as zero or any other arbitrary initial value, thereby performing a self-calibration and self-test. Apparatus 10 may also comprise a calibration mode. For example, after a predefined period of time or amount of measurements, mass 16 may be moved to the known calibration point, whereupon a sensor, such as sensor 28 or some other kind of sensor, such as but not limited to, a load cell or a limit switch (e.g., light beam, inductive, mechanical, or any other suitable switch or sensor), senses mass 16 reaching the calibration point and provides an indication (e.g., visual or audible) that mass 16 has reached the calibration point. Any inaccuracies or discrepancies between the known calibration point and the measured point may be easily detected and recorded. For example, if the measured calibration position is outside a predefined tolerance range (e.g., >±5 mm) then a warning alarm may be sent for servicing. If the measured calibration position is within the predefined tolerance range, then apparatus 10 may calibrate/reset itself and restart operation.

Reference is now made to FIG. 2C. Instead of mass 16 being lowered into a material, mass 16 may be lifted from a first material to a second material. For example, mass 16 may initially rest at an equilibrium position Q in water (e.g., the bottom of a well), and then be lifted out of the water. As soon as mass 16 is lifted out of the water, there is a sudden change in the time derivative of the spatial position of mass 16, i.e., mass 16 accelerates due to the change in drag from moving in water as opposed to air. This acceleration of mass 16 may be sensed and measured by sensor 28. It is noted that the lifting of mass 16 from the water to air may also be sensed by a load cell, for example, as a difference in weight of mass 16. (The phenomena of the acceleration of mass 16 and difference in its weight are equivalent in the operation of apparatus 10, as is well known from the formula f=mA, wherein f is force, m is mass and A is acceleration.) The distance E traveled by mass 16 from equilibrium position Q to the point of leaving the water may be sensed and measured by shaft encoder 23. In such a manner, apparatus 10 may be used to measure depth of a well, for example.

As another example, mass 16 may be at least partially submerged in a material, such as but not limited to, water. Instead of mass 16 moving, mass 16 is at rest and the water goes up or down relative to mass 16. (Such movement of water may occur during seismic activity, for example.) The movement of the water relative to mass 16 may be sensed by sensor 28 as a force or acceleration due to the change in the weight or buoyancy of mass 16, since as mentioned before, the acceleration of mass 16 and the difference in its weight are equivalent in the operation of apparatus 10.

Auxiliary mass 20 maintains filament 14 generally taut and thus stabilizes the operation of apparatus 10. In addition, auxiliary mass 20 may also be used to impact a surface or to be pulled from a material, as described hereinabove for mass 16. Since the distance between mass 16 and auxiliary mass 20 is known, comparison of the changes of time derivatives of the spatial positions of mass 16 and auxiliary mass 20 may be used to monitor water level or depth, for example. It is noted that since apparatus 10 measures the change of a time derivative of the spatial position of mass 16 (and auxiliary mass 20), apparatus 10 is generally undisturbed by any friction between mass 16 inside tube 18 or hole 19. In addition, apparatus 10 is generally unaffected by environmental factors, such as weather changes, for example.

In accordance with another preferred embodiment of the present invention, apparatus 10 may be used as an early warning detector for earthquakes and other seismic activity, as is now explained.

It is known that prior to earthquakes, there is a significant change in the water level of wells and aquifers. The change in water level may precede the earthquake in the range of a few minutes to hours, depending on the distance of the seismicity from the well and the magnitude of the seismicity. If mass 16 is at an equilibrium position in the water (fully or partially submerged), then the change in water level, whether up or down, imparts an impact, acceleration, deceleration or jerk to mass 16, which is sensed by sensor 28. Since mass 16 has not been moved by motor 24, controller 30 may interpret the sensed change in a time derivative of the spatial position of mass 16 as a precursor of seismicity.

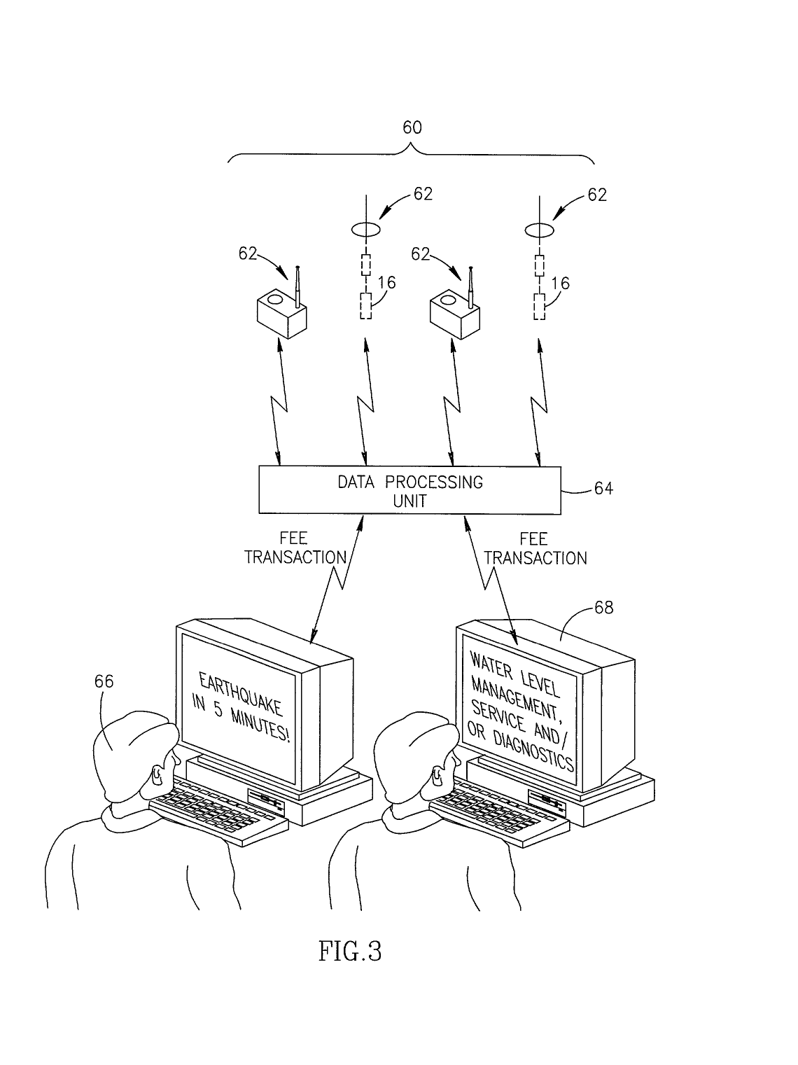

Reference is now made to FIG. 3, which illustrates a system 60 for early warning of earthquakes or other seismicity, constructed and operative in accordance with a preferred embodiment of the present invention. System 60 preferably includes one or more early warning detectors 62 that provide a signal corresponding to an early warning of an earthquake. Detectors 62 may comprise apparatus 10 as described hereinabove, or any other kind of seismic detector. Preferably, detectors 62 are positioned at a plurality of strategically selected positions with respect to populated areas and areas of seismic activity. A data processing unit 64, such as the data processing unit 40 described hereinabove, receives the signals from detectors 62. Data processing unit 64 processes the signals and decides if the signals are precursors of an earthquake or other significant seismic activity. Data processing unit 64 may then send a message based upon the signals to one or more subscribers 66, such as via a telecommunications medium, e.g., the Internet or a cellular telephone network, for example.

The subscribers 66 preferably receive the message from data processing unit 64 through a fee transaction. For example, a cellular telephone service provider may be sold the information from data processing unit 64, and the service provider may in turn collect a fee from the subscribers 66 for provision of such earthquake information. Data processing unit 64 may be in interactive communication with the subscribers 66. For example, subscribers 66 may be able to interrogate data processing unit 64 regarding the current earthquake information or a history of such information, which may me stored in memory in data processing unit 64.

Of course, system 60 may also be used by a municipality or water authority not just for early warning of seismicity, but also as a system 68 for water level measurement, service and/or diagnostics. For example, system 68 allows the municipality or water authority to know which well out of thousands of wells is low and stop pumping supply water from that well, thereby preventing sand or sea water problems in the water supplied to consumers. System 68 may also operate with a fee transaction.

As mentioned hereinabove, control circuitry 38 may include various environmental sensors, such as but not limited to, temperature sensors, humidity sensors, wind sensors and the like, which may be processed and transmitted by controller 30. System 60 may incorporate the environmental data in its prediction of seismic activity. For example, system 60 may compare environmental data that preceded past earthquakes with the currently measured environmental data as an additional factor in predicting the severity of an impending earthquake. System 68 may incorporate the environmental data in its water level measurement, service and/or diagnostics, for example.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. Apparatus comprising:
a mass suspended from a filament; and
a sensor adapted to sense a change in a time derivative of a spatial position of said mass when said mass moves from a first material to a second material.

2. Apparatus according to claim 1 wherein said change in the time derivative of a spatial position of said mass comprises acceleration of said mass.

3. Apparatus according to claim 1 wherein said change in the time derivative of a spatial position of said mass comprises deceleration of said mass.

4. Apparatus according to claim 1 wherein said change in the time derivative of a spatial position of said mass comprises jerk of said mass.

5. Apparatus according to claim 1 wherein said change in the time derivative of a spatial position of said mass comprises impact of said mass with a material.

6. Apparatus according to claim 1 wherein said change in the time derivative of a spatial position of said mass comprises said mass being removed from a liquid to a gas.

7. Apparatus according to claim 1 wherein said change in the time derivative of a spatial position of said mass comprises said mass moving due to seismicity.

8. Apparatus according to claim 1 wherein said sensor comprises an accelerometer.

9. Apparatus according to claim 1 wherein said sensor comprises a load cell.

10. Apparatus according to claim 1 and further comprising an impact enhancer attached to said mass.

11. Apparatus according to claim 1 and further comprising a filament mover adapted to move said filament and said mass.

12. Apparatus according to claim 1 and further comprising a filament-displacement sensor adapted to sense a distance moved by said filament and said mass.

13. Apparatus according to claim 12 and further comprising a data processing unit adapted to process said change in a time derivative of said spatial position of said mass, and to correlate the change in a time derivative of said spatial position of said mass with a distance traveled by said mass from an equilibrium position.

14. Apparatus according to claim 13 wherein said mass is arranged to be at least partially submerged in a volume of water and said data processing unit is adapted to provide at least one of level measurement, service and diagnostics of said volume of water.

15. Apparatus comprising:
a mass suspended from a filament and disposed in a material; and
a sensor adapted to sense a change in a time derivative of a spatial position of said mass due to relative movement between said mass and said material.

16. A system comprising:
a detector adapted to provide a signal corresponding to an early warning of an earthquake; and
a data processing unit adapted to receive said signal and send a message based upon said signal to a subscriber.

17. The system according to claim 16 wherein said data processing unit is in operative communication with a plurality of said detectors.

18. The system according to claim 16 wherein said data processing unit is operative to send said message via a telecommunications medium.

19. The system according to claim 16 wherein said subscriber receives said message through a fee transaction.

20. The system according to claim 16 wherein said data processing unit is in interactive communication with said subscriber.

21. A method comprising:
providing an early warning of an earthquake; and
sending a message based upon said early warning to a subscriber.

22. The method according to claim 21 wherein said providing comprises receiving a signal from an early warning earthquake detector.

23. The method according to claim 21 wherein said providing comprises receiving a signal from a network of early warning earthquake detectors.

24. The method according to claim 21 wherein said sending comprises sending said message via a telecommunications medium.

25. The method according to claim 21 wherein said sending comprises sending said message through a fee transaction.

26. A method comprising:
providing a mass suspended from a filament and disposed in a material; and
sensing a change in a time derivative of a spatial position of said mass due to relative movement between said mass and said material.

27. The method according to claim 26 and further comprising correlating the change in a time derivative of said spatial position of said mass with a distance traveled by said mass from an equilibrium position.

28. The method according to claim 27 and further comprising calibrating a position of said mass.

29. The method according to claim 26 wherein said mass is arranged to be at least partially submerged in a volume of water, and further comprising providing at least one of level measurement, service and diagnostics of said volume of water.

30. The method according to claim 29 wherein said at least one of level measurement, service and diagnostics of said volume of water is provided through a fee transaction.

31. The method according to claim 26 and further comprising sensing an environmental factor.
